(19) United States
(12) Patent Application Publication
(10) Pub. No.: US 2013/0341486 A1
(43) Pub. Date: Dec. 26, 2013

(54) APPARATUS FOR OBTAINING 3D INFORMATION USING PHOTODETECTOR ARRAY

(71) Applicant: ELECTRONICS AND TELECOMMUNICATIONS RESEARCH INSTITUTE, Daejeon (KR)

(72) Inventors: MyoungSook OH, Daejeon (KR); Bongki MHEEN, Daejeon (KR); Jae-Sik SIM, Daejeon (KR); Kisoo KIM, Daejeon (KR); Yun Jeong LEE, Daejeon (KR); Yong-Hwan KWON, Daejeon (KR); Eun Soo NAM, Daejeon (KR)

(73) Assignee: Electronics and Telecommunications Research Institute, Daejeon (KR)

(21) Appl. No.: 13/755,470

(22) Filed: Jan. 31, 2013

(30) Foreign Application Priority Data
Jun. 25, 2012 (KR) 10-2012-0067891

(51) Int. Cl. G01J 1/42

(52) U.S. Cl. CPC G01J 1/42
USPC 250/206; 250/216

(57) ABSTRACT

The present disclosure relates to an apparatus for obtaining 3D information using a photodetector array. The apparatus for obtaining 3D information includes: a light source unit configured to generate an optical signal of a predetermined wavelength band; a light transmission optical lens unit provided on a path of the optical signal and configured to emit the optical signal output from the light source unit in parallel or at a predetermined angle; an optical scanning unit configured to scan the light output from the light transmission optical lens unit to a surface of an object to be measured; a light reception optical lens unit configured to collect the light reflected from the surface of the object; and a photodetection unit configured to convert collected optical signals into respective electrical signals by arraying one or more photodetectors such that light reception portions thereof are collected at a center.

### CROSS-REFERENCE TO RELATED APPLICATIONS

This application is based on and claims priority from Korean Patent Application No. 10-2012-0067891, filed on Jun. 25, 2012 with the Korean Intellectual Property Office, the disclosure of which is incorporated herein in its entirety by reference.

### TECHNICAL FIELD

The present disclosure relates to an apparatus for obtaining 3D information using a photodetector array, and more particularly to, an apparatus for obtaining 3D information which detects information on a wide region by arraying photodetectors when light of a laser radar for measuring a 3D image is reflected from a target object and incident to the photodetectors through a light reception lens to measure a 3D image.

### BACKGROUND

In general, a laser radar detects an optical signal by using an optical lens system having a telescope structure and a detector of received light in order to collect light reflected or scattered from in a certain object at a long distance by using a wavelength of a near infrared band. In this case, in order to scan a wider region, a transmission optical system and a reception optical system may be arrayed in an equal axis. When the transmission optical system and the reception optical system are coaxially configured, there is an advantage in that a wider region may be scanned, but a problem occurs that light incident to a center axis is lost without being detected as a signal.

However, when the transmission optical system and the reception optical system are not coaxially configured, there is a disadvantage in that a measurement distance is limited due to a difference of two optical axes. When a light receiving area of a photodetector is enlarged, a reception band is lowered, which thus becomes a large limitation factor when a modulated optical signal, such as a pulse light source, is used.

### SUMMARY

The present disclosure has been made in an effort to enlarge a measurement region by expanding a reception area by arraying photodetectors in order to solve a disadvantage that a region of an object which can be measured is narrow when a transmission optical axis is different from a reception optical axis.

An exemplary embodiment of the present disclosure provides an apparatus for obtaining 3D information, including: a light source unit configured to generate an optical signal of a predetermined wavelength band; a light transmission optical lens unit provided on a path of the optical signal and configured to emit the optical signal output from the light source unit in parallel or at a predetermined angle; an optical scanning unit configured to scan the light output from the light transmission optical lens unit to a surface of an object to be measured; a light reception optical lens unit configured to collect the light reflected from the surface of the object; and a photodetection unit configured to convert collected optical signals into respective electrical signals by arraying one or more photodetectors such that light reception portions thereof are collected at a center.

The apparatus for obtaining 3D information may include an optical bandpass filter which is positioned in the front or rear of the light reception optical lens unit and removes noise of incident light.

In the photodetector array, the respective photodetectors may be arranged so that light reception areas thereof are collected at a center.

The apparatus for obtaining 3D information may include a signal processor configured to measure a time from a light transmission time to a light reception time of the optical signal or strength of the optical signal reflected from the object by processing a signal output from the photodetection unit.

According to the present disclosure, when photodetectors are arranged in an array type, 3D information on an object having a wider region is detected, compared to a case in which scanning is performed in a state where a transmission optical axis is different from a reception optical axis.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic configuration diagram of a laser radar for detecting a 3D image according to an exemplary embodiment of the present disclosure.

FIG. 2 is a diagram illustrating a photodetector array of a laser radar according to an exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

The present disclosure relates to a configuration of a system of a laser radar for detecting a 3D image, and is to collect information, such as a distance from the object by transmitting transmits light to an object to be measured by using a light transmission lens and a scanner by using a light source of a near infrared wavelength band and collecting light reflected from the object by a light reception lens.

In order to overcome a limitation of the decrease in a reception bandwidth due to expansion of a light reception area, the present disclosure is to detect information on a wider region of a measured object by arranging a plurality of single photodetectors so that light reception portions thereof are collected at a center and achieving an effect in that a light reception area is widened.

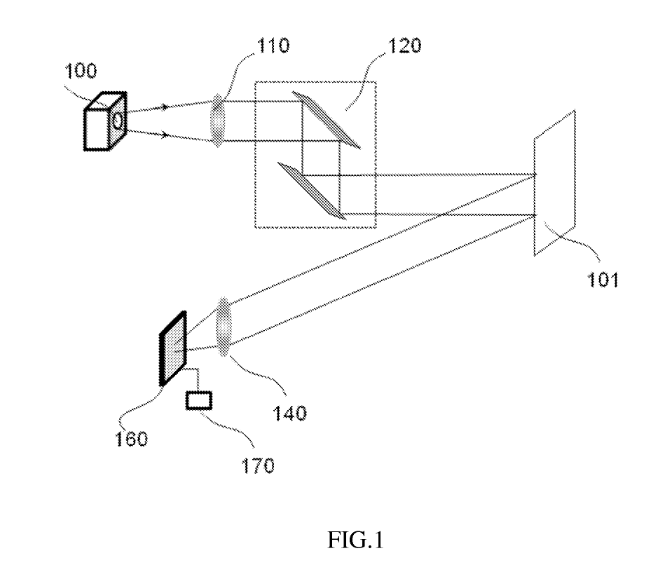

FIG. 1 is a schematic configuration diagram of a laser radar according to an exemplary embodiment of the present disclosure. The laser radar includes a light source 100, a light transmission optical lens unit 110, an optical scanning unit 120, a light reception optical lens unit 140, an optical bandpass filter (not illustrated), a photodetection unit 160 and a signal processor 170.

The light source 100 may be a light source for generating an optical signal of a predetermined wavelength band in a form of a pulse or a light source of a near infrared wavelength band in a frequency-modulated continuous-wave (FMCW) method of a frequency modulation method. The light source 100 may generate an optical signal by using solid laser, semiconductor laser or the like.

The light transmission optical lens unit 110 serves to emit the optical signal output from the light source 100 in parallel or at a predetermined angle.

The optical scanning unit 120 serves to scan the optical signal emitted from the light transmission optical lens unit 110 to a region desired to be measured. The optical scanning unit 120 may scan the optical signal so that the optical signal is incident to one point of an object 101 or a surface of the object 101. The optical scanning unit 120 may adjust the optical signal emitted from the light transmission lens unit 110 and scan the adjusted optical signal in order to scan a wide region of the object 101.

The light reception optical lens unit 140 may adjust a focus of the optical signal reflected from the object 101 to a light reception area of an array of one or more photodetectors of the photodetection unit 160. The light reception optical lens unit 140 serving to collect the signal reflected from the object in the photodetector may include at least one or more light reception optical lens, and may have a shape of a globular lens.

The optical bandpass filter unit (not illustrated) serves to pass only a signal of a preset bandwidth in order to remove noise of the light incident from the light reception optical lens unit 140. The optical bandpass filter unit may be positioned in a front surface or a rear surface of the light reception optical lens unit 140. When the optical bandpass filter unit is positioned in the rear surface, the optical bandpass filter unit receives the optical signal output from the light reception optical lens unit 140 and performs band-filtering on the received optical signal. However, when the optical bandpass filter unit is positioned in the front surface, the optical bandpass filter unit may receive the optical signal reflected from the object 101, perform a band-filtering on the received optical signal, and transfer the band-filtered optical signal to the light reception optical lens unit 140.

The photodetection unit 160 is formed of one or more arrayed photodetectors, and serves to convert the light collected in the light reception optical lens unit 140 into a desired electrical signal by using a sensor module for detecting the light. In order to measure objects located at various distances, the photodetection unit 160 detects the optical signals collected in the sensor module while focusing the optical in the center.

The signal processor 170 may process the signals converted by the photodetection unit 160, that is, the one or more arrayed photodetectors and obtain a measurement distance or strength of the optical signal reflected from the object 101 based on a time from a light transmission time to a light reception time of the optical signal.

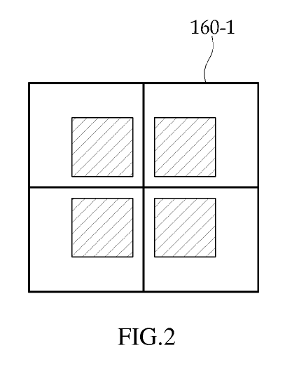

The photodetection unit 160 in which one or more photodetectors are arrayed is configured so as to obtain an effect in that the light reception area is widened by arraying the photodetectors 160-1 so that light reception areas are collected at the center as illustrated in FIG. 2. FIG. 2 is merely an example of the photodetector array, and the photodetector array may have other forms if the photodetectors are arrayed so that the light reception areas of the photodetectors are collected at the center. In this case, the photodetector array may be implemented by an array of single elements or by an array of respective optically isolated photodetectors.

From the foregoing, it will be appreciated that various embodiments of the present disclosure have been described herein for purposes of illustration, and that various modifications may be made without departing from the scope and spirit of the present disclosure. Accordingly, various embodiments disclosed herein are not intended to be limiting, with the true scope and spirit being indicated by the following claims.

What is claimed is:

1. An apparatus for obtaining 3D information, comprising:
a light source unit configured to generate an optical signal of a predetermined wavelength band;
a light transmission optical lens unit provided on a path of the optical signal and configured to emit the optical signal output from the light source unit in parallel or at a predetermined angle;
an optical scanning unit configured to scan the light output from the light transmission optical lens unit to a surface of an object to be measured;
a light reception optical lens unit configured to collect the light reflected from the surface of the object; and
a photodetection unit configured to convert collected optical signals into respective electrical signals by arraying one or more photodetectors such that light reception portions thereof are collected at a center.

2. The apparatus of claim 1, further comprising:
an optical bandpass filter positioned in the front or rear of the light reception optical lens unit and configured to make a signal of a preset bandwidth among the incident optical signals pass.

3. The apparatus of claim 1, wherein in the photodetection unit, one or more photodetectors are arrayed and respective light reception portions thereof are collected at a center so that a portion in which light is not detected is minimized.

4. The apparatus of claim 1, further comprising:
a signal processor configured to measure a measurement distance or strength of the optical signal reflected from the object by processing a signal output from the photodetection unit through a time from a light transmission time to a light reception time of the optical signal.
